(19) United States
(12) Patent Application Publication
(10) Pub. No.: US 2015/0003041 A1
(43) Pub. Date: Jan. 1, 2015

(54) LIGHTING DEVICE

(71) Applicant: OSRAM GmbH, Muenchen (DE)

(72) Inventors: Shengmei Zheng, Shenzhen Guangdong (CN); Peng Chen, Shenzhen Guangdong (CN); Chuanpeng Zhong, Shenzhen Guangdong (CN); Yusheng Ming, Shenzhen Guangdong (CN)

(21) Appl. No.: 14/362,613

(22) PCT Filed: Dec. 5, 2012
(86) PCT No.: PCT/EP2012/074539

§ 371 Date: Jun. 4, 2014

(30) Foreign Application Priority Data
Dec. 6, 2011 (CN) 201110401531.8

(51) Int. Cl. F21K 99/00; F21V 14/00; F21V 13/08

(52) U.S. Cl. CPC F21K 9/58; F21K 9/56; F21V 13/08; F21V 14/003
USPC 362/84

(57) ABSTRACT

A lighting device may include a circuit board with at least one LED chip thereon, sidewalls extending from the circuit board, and a phosphor cover supported on the sidewalls, wherein the circuit board, the phosphor cover, and the sidewalls define a cavity accommodating at least one LED chip, wherein the lighting device further comprises at least one optical member arranged in the cavity, and the optical member has an adjustable reflectivity to adjust the spectral power distribution of emitted light through the phosphor cover and/or the CCT of the emitted light.

### RELATED APPLICATIONS

The present application is a national stage entry according to 35 U.S.C. §371 of PCT application No.: PCT/EP2012/074539 filed on Dec. 5, 2012, which claims priority from Chinese application No.: 201110401531.8 filed on Dec. 6, 2011, and is incorporated herein by reference in its entirety.

### TECHNICAL FIELD

Various embodiments relate to a lighting device.

### BACKGROUND

With the development of LED illumination techniques, more and more people use an LED lighting device as a light source for applications to various environments. As for a lighting device with a fixed light source, the characteristics of light emitted by the light source are generally set, for example, spectral power distribution, CCT, CRI, and so on. However, in many specific application environments such as hotels, malls, or residential buildings, it may be desired to tune the hue of the output light of the lighting device, especially the CCT, to change the lighting atmosphere according to the need or the mood of people, for example, the lighting device emits a warm white light when a user spends his leisure time, while the lighting device emits a cool white light when a user studies and works.

In the related art, a single color LED is generally provided, for example, a phosphor cover is provided for a blue LED to mix light. US 2009/0103293 A1 discloses a lighting device, wherein a plurality of phosphor covers are provided for generating emitted light with different CCT. In such a lighting device an additional accommodation space needs to be provided for part of unused phosphor covers, and the CCT is not uniform across the lighting surface or can merely be tuned non-continuously. U.S. Pat. No. 7,942,540 B2 discloses an illumination device for mixing light for an LED with a phosphor cover, wherein the phosphor covers arranged alternatively are inserted into the lighting device in the form of sidewalls to adjust the CCT. However, such a lighting device needs a larger accommodation part for the inserted phosphor covers, and the manufacturing and inserting processes are relatively complicate.

### SUMMARY

In order to solve the technical problems above, various embodiments provide a lighting device, which is easy to manufacture and compact in structure and may obtain a uniform, continuous adjustable CCT on a lighting surface.

The lighting device according to various embodiments includes a circuit board with at least one LED chip mounted thereon, sidewalls extending from the circuit board, a phosphor cover supported on the sidewalls, the circuit board, the phosphor cover, and the sidewall define a cavity accommodating at least one LED chip, characterized in that, the lighting device further includes at least one optical member arranged in the cavity, and the optical member has an adjustable reflectivity to adjust the spectral power distribution of emitted light through the phosphor cover and/or the CCT of the emitted light.

The concept of the present disclosure lies in, instead of providing a plurality of phosphor covers capable of realizing different light mixing effects to adjust the spectral power distribution and/or CCT, using an optical member in combination with one single phosphor cover to perform adjustment of the light through the phosphor cover. To be specific, at least part of light emitted by an LED chip and excited light generated by the phosphor cover are incident on the optical member, and the amount of light emitted by an LED chip and excited light generated by the phosphor cover, reflected by the optical member to the phosphor cover, is controlled by the adjustable reflectivity of the optical member. Thus, the proportion of light with different wavelengths emitted through the phosphor cover can be controlled, viz. the spectral power distribution and/or CCT of the emitted light can be controlled.

In various embodiments, the reflectivity of the optical member can be adjusted in a range from a full reflection state to a reflection state finally to a non-reflection state. The optical members is considered to be in the full reflecting state when its reflectivity is higher than 90% and in the non-reflecting state when its reflectivity is between 0% and 10%. In this way, the light incident on the optical member, especially the excited light, may be reflected, transmitted, or absorbed so as to realize the continuous adjustment of the CCT. Preferably, the reflectivity of the optical member in the reflection state is adjusted in a first range from 10% to 20% and in a second range from 80% to 90%.

In various embodiments, the optical member has a plurality of regions, the plurality of regions having different reflectivities. Preferably, there are a plurality of the optical members, the plurality of the optical members having reflectivities different from each other.

In various embodiments, the optical member is disposed on the circuit board and/or on inner surfaces of the sidewalls. The area where the excited light is reflected and transmitted is increased by increasing the area of the optical member, which may control and adjust the CCT of light from the lighting device more accurately.

In various embodiments, the reflectivity of the optical member is adjusted by changing a supply voltage of the optical member. The voltage externally applied to the optical member may be adjusted to adjust the reflectivity of the optical member.

In various embodiments, the optical member is electrically connected to the circuit board to receive a supply voltage. The circuit board of the lighting device may supply power for the optical member to adjust the supply voltage of the optical member, thereby adjusting the reflectivity of the optical member according to different voltages.

In various embodiments, the LED chip is a blue LED chip, a first part of blue light of the LED chip passes through gaps between phosphor particles of the phosphor cover and emerge, a second part of blue light interacts with the phosphor particles to produce yellow light, and a third part of blue light is incident on the circuit board and/or the sidewalls. The first part of blue light emitted by the blue LED chip toward the phosphor cover does not interact with the phosphor particles and is emitted directly through the phosphor cover. The second part of blue light is interacted and mixed with the phosphor particles to form warm yellow light. The third part of blue light emitted by the blue LED chip may strike the circuit board and/or the sidewalls.

In various embodiments, a first part of yellow light of the yellow light generated by the second part of blue light emerge through the phosphor cover, and mixed with the emitted first part of blue light into white light. A second part of yellow light is reflected back to the inside of the enclosed cavity, for example, being reflected back to the circuit board and/or the sidewalls. The amount of third part of blue light and the amount of the second part of yellow right, which is reflected to the phosphor cover, may be controlled via the optical member arranged on the circuit board and/or the sidewalls.

In various embodiments, when the optical member is not in the non-reflection state, the second part of yellow light and the third part of blue light are at least partly reflected by the optical member to the phosphor cover. In said state, the optical member has the properties of a mirror and is capable of reflecting somewhat the second part of yellow light and the third part of blue light according to the requirements of the application environments, allowing the light to be emitted through the phosphor cover.

In various embodiments, the non-reflection state is full transmission state. Preferably, the optical member is designed as a liquid crystal screen. The optical member may certainly be other devices with adjustable reflectivity, for example, a multilayered film or the like manufactured by an Mg—Ni alloy, compounds of transition metal elements or compounds of rare earth elements. The optical member may be designed as a liquid crystal screen with optical characteristics, the light reflectivity of which is, for example, greater than 87% in a full reflection state; the transmissivity of which is, for example, greater than 87% in a full transmission state; and the transmissivity and reflectivity of which are, for example, both 43% in a translucence state.

In various embodiments, when the optical member is in the full transmission state, the second part of yellow light and the third part of blue light pass through the optical member and are incident on the circuit board and/or the sidewalls. In said state, the optical member has light transmission properties similar to glass, allowing the second part of yellow light and the third part of blue light to be transmitted directly through the optical member as much as possible to reach the sidewalls and/or the circuit board.

In various embodiments, the side walls are made of a light absorbing material. The sidewalls may be, for example, formed of a black porous material or the sidewalls may be coated with a light absorbing coating, the second part of yellow light and the third part of blue light pass through the optical member and is incident on the sidewalls and are absorbed high efficiently.

In various embodiments, the non-reflection state is full absorption state. Preferably, the optical member is made of any one of the Mg₂NiHx, Mg₂CoHx and Mg₂FeHx. This can be achieved by choosing different material and choosing different power supply.

In various embodiments, when the optical member is in the full absorption state, the second part of yellow light and the third part of blue light are absorbed.

In various embodiments, the optical member has a plurality of regions, and these regions have different reflectivities. For example, the reflectivity of the area with the optical member provided on the inner surface of the sidewall may be different from that of the area with the optical member provided on the circuit board. Thus, the desired optical effect maybe obtained.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments.

In the following description, various embodiments described with reference to the following drawings, in which:

FIG. 1 is a view of a first embodiment of a lighting device according to the present disclosure in cross-section, wherein the optical member is in a full reflection state;

FIG. 2 is a view of a second embodiment of a lighting device according to the present disclosure, wherein the optical member is in a non-reflection state; and

FIG. 3 is a wavelength-radiation power diagram of a lighting device according to the present disclosure in the case where merely the reflectivity of the optical member mounted on the circuit board is changed and other conditions are the same.

### DETAILED DESCRIPTION

The following detailed description refers to the accompanying drawing that show, by way of illustration, specific details and embodiments in which the disclosure may be practiced.

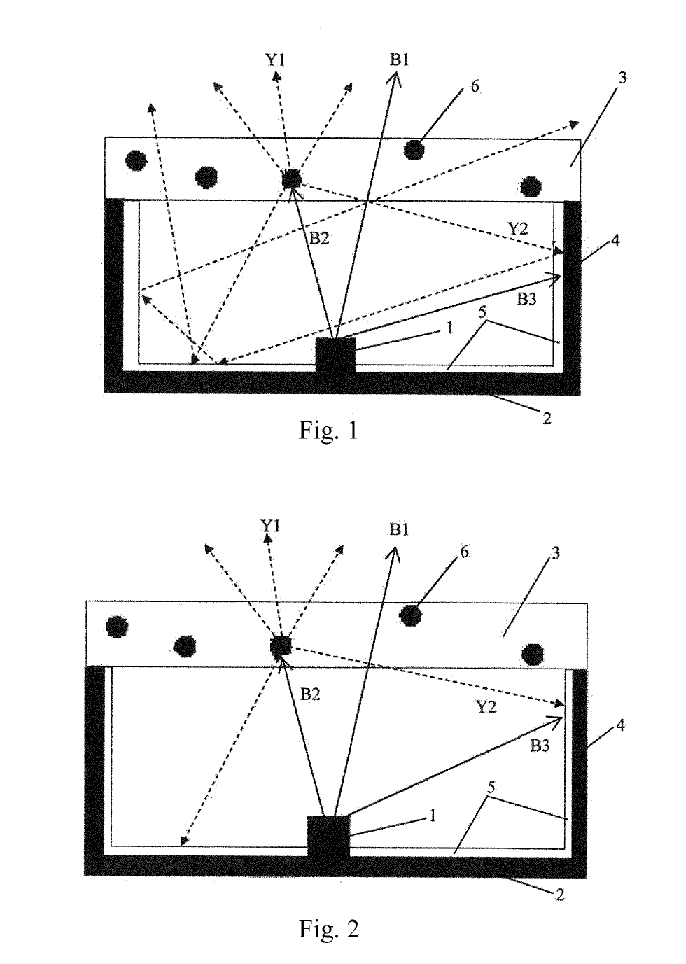

FIG. 1 is a view of a first embodiment of a lighting device according to the present disclosure in cross-section. As shown, the lighting device may be, for example, in the form of cylinder, cuboid or cube, comprising a phosphor cover 3 as a top surface, a circuit board 2 as a bottom surface and sidewalls 4 defining a cavity R with the phosphor cover 3 and the circuit board 2. In the enclosed cavity R, at least one blue LED chip 1 is mounted on the circuit board, the LED chip 1 emits a first part of blue light B1 and a second part of blue light B2 toward the phosphor cover 3, and the LED chip 1 further emits a third part of blue light B3 toward the sidewalls 4. In the lighting device according to the present disclosure, the phosphor cover 3 is formed of a light transmissive material such as PC, PMMA, doped with phosphor particles 6; and the sidewalls 4 are made of a light absorbing material, for example made of a black porous material, or the sidewalls 4 may be coated with a light absorbing coating.

In order to realize the control of the CCT of the lighting device, viz. controlling and adjusting the spectral power distribution of the emitted light passing through the phosphor cover 3, an optical member 5 with adjustable reflectivity is provided at one side facing the enclosed cavity R of the sidewalls 4 and/or the circuit board 2 in the present disclosure. Preferably, around the LED chip 1 on the circuit board 2 there is mounted such optical member 5, which is, for example, a liquid crystal screen with optical characteristics. Such optical member 5 is electrically connected to the circuit board 2 and the reflectivity of the optical member 5 is adjusted by providing different voltages via the circuit board 2, for example, gradually adjusting from a full reflection state to a non-reflection state. The optical member 5 is considered to be in the full reflecting state when the reflectivity of the optical member 5 is between 90% and 100%; The optical member 5 is considered to be in the non-reflection state when the reflectivity of the optical member 5 is between 0% and 10%. The reflectivity of the optical member 5 in the reflection state may be adjusted between a first range from 10% to 20% and a second range from 80% to 90%. In this embodiment, the first range from 10% to 20% may be considered to be one low reflectivity range and the second range from 80% to 90% may be considered to be one high reflectivity range.

FIG. 1 illustrates a first embodiment of the lighting device according to the present disclosure when the optical member 5 is in a full reflection state. The first part of blue light B1 of the blue LED chip 1 passes directly through gaps between the phosphor particles 6 of the phosphor cover 3 to be emitted outward, therefore, the emitted light does not activate the phosphor particles 6 to generate yellow light but remains as blue light; meanwhile, the second part of blue light B2 of the blue LED chip 1 is also emitted into the phosphor cover 3, however, different from the first part of blue light 1, the second part of blue light B2 activates the phosphor particles 6 to generate yellow light. A first part of yellow light Y1 generated passes through the phosphor cover 3 to be emitted outward and mixed with the first part of blue light B1 to form white light, while the second part of yellow light Y2 is reflected back to the inside of the enclosed cavity R and strike directly the optical member 5 provided on the sidewall 4 and/or the circuit board 2. The LED chip 1 further emits the third part of blue light B3 directly striking the sidewalls 4 and the third part of blue light B3 occupied a small portion of total blue light. Since the optical member 5 is adjusted herein to a reflection state by a control voltage outputted by the circuit board 2, the optical member 5 may be regarded as a mirror. The optical member 5 reflects the second part of yellow light Y2 and the third part of blue light B3 with a reflectivity of, for example, greater than 85%. Therefore, the effect of almost full reflection maybe realized in the cavity R, and a large amount of yellow light is finally reflected and is emitted outward after passing through the phosphor cover 3 substantially without loss, such that the proportion of the yellow light in the final emitted light is relatively high so as to obtain a relatively low CCT.

FIG. 2 is a view of a second embodiment of a lighting device according to the present disclosure when the optical member 5 is in a non-reflection state. The optical member 5 is gradually adjusted via the control voltage outputted by the circuit board 2 to a translucence state and finally adjusted to a non-reflection state as shown by FIG. 2. Herein, the optical member 5 has, for example, a transmissivity of greater than 84%, thus, the optical member 5 may be approximately regarded as light transmissive glass. The second part of yellow light Y2 and the third part of blue light B3, passing through the surface of the optical member 5, are further emitted to the circuit board 2 or to the sidewall 4 behind the optical member 5, almost without reflection and block. Based on the light absorbing property of the sidewalls 4, the third part of blue light B3 and the second part of yellow light Y2 are almost fully absorbed. In this case, a large amount of the yellow light is absorbed and cannot be emitted, such that the proportion of the yellow light in the emitted light is relatively low, thereby obtaining a relatively high CCT.

In this embodiment, the optical member 5 may alternatively be in the full absorption state. The third part of blue light B3 and the second part of yellow light Y2 are almost fully absorbed by the optical member 5 directly, through the adjusting of the control voltage of the optical member 5. Preferably, the optical member is made of any one of the Mg₂NiHx, Mg₂CoHx and Mg₂FeHx.

Certainly, during the adjustment process of the optical member 5 from the full reflection state to the translucence state finally to the non-reflection state, the second part of yellow light Y2 is absorbed more and more, whereby the CCT of the white light generated by the lighting device through mixing light may be continuously adjusted and controlled according to requirements of actual applications. In addition, the optical member 5 has a plurality of regions, and these regions have different reflectivities. For example, the reflectivity of the area with the optical member 5 provided on the inner surface of the sidewall 4 may be different from that the reflectivity of the area with the optical member 5 provided on the circuit board 2. Thus, the desired optical effect may be obtained.

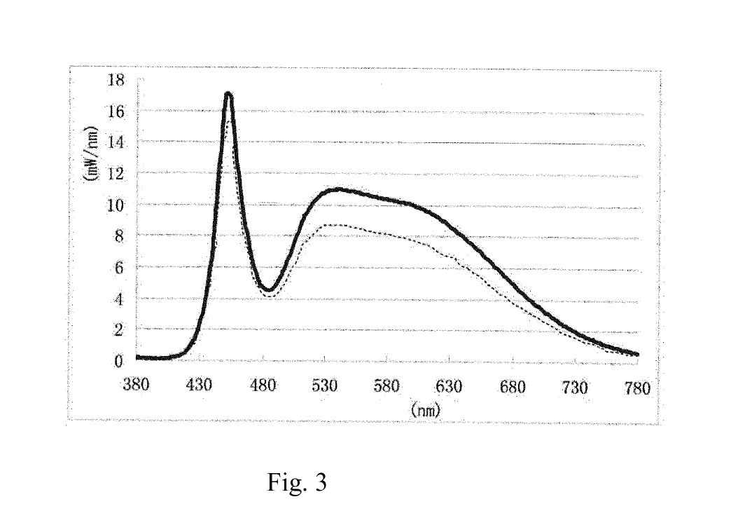

FIG. 3 is a wavelength-radiation power diagram of a lighting device according to the present disclosure in which the reflectivity of the optical member 5 mounted on the circuit board 2 is adjusted. The test result is based on a T8 tube. What is represented by a dotted line is an emitting spectrum when the optical member 5 mounted on the circuit board 2 is in a low reflection state (the reflectivity is about 80%), wherein the CCT is 5507K and the CRI is 89. What is represented by a solid line is an emitting spectrum when the optical member 5 mounted on the circuit board 2 is in a high reflection state (the reflectivity is about 99%), wherein the CCT is 5053K and the CRI is 87.2.

As maybe seen from said diagram, since the wavelength of the blue light is generally between 420 to 480 nm and the wavelength of the yellow light is generally between 500 to 680 nm, the peak region on the left side of the diagram represents the blue light part, and the peak region on the right side of the diagram represents the yellow light part. When the reflectivity of the optical member is increased, the blue light peak is increased by 10%, and the yellow light peak is increased by 25%. And the width of the spectral line of yellow light is greater than the width of the spectral line of blue light, thus, the CCT of the emitted light will be lowered.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE SIGNS

1 LED chip

2 circuit board

3 phosphor cover

4 sidewalls

5 optical member

6 phosphor particles

R cavity

B1 first part of blue light

B2 second part of blue light

B3 third part of blue light

Y1 first part of yellow light

Y2 second part of yellow light

1. A lighting device, comprising a circuit board with at least one LED chip thereon, sidewalls extending from the circuit board, and a phosphor cover supported on the sidewalls, and wherein the circuit board, the phosphor cover, and the sidewalls define a cavity accommodating at least one LED chip,
wherein the lighting device further comprises at least one optical member arranged in the cavity, and the optical member has an adjustable reflectivity to adjust the spectral power distribution of emitted light through the phosphor cover and/or the CCT of the emitted light.

2. The lighting device according to claim 1, wherein the reflectivity of the optical member can be adjusted in a range from a full reflection state to a reflection state finally to a non-reflection state.

3. The lighting device according to claim 2, wherein the reflectivity of the optical member in the reflection state is adjusted between a first range from 10% to 20% and a second range from 80% to 90%.

4. The lighting device according to claim 2, wherein the optical member has a plurality of regions, the plurality of regions having different reflectivities.

5. The lighting device according to claim 4, wherein there are a plurality of the optical members, the plurality of the optical members having reflectivities different from each other.

6. The lighting device according to claim 1, wherein the optical member is disposed on the circuit board and/or on inner surfaces of the sidewalls.

7. The lighting device according to claim 6, wherein the reflectivity of the optical member is adjusted by changing a supply voltage of the optical member.

8. The lighting device according to claim 7, wherein the optical member is electrically connected to the circuit board to receive a supply voltage.

9. The lighting device according to claim 8, wherein the LED chip is a blue LED chip, a first part of blue light of the LED chip passes through gaps between phosphor particles of the phosphor cover and emerge, a second part of blue light interacts with the phosphor particles to produce yellow light, and a third part of blue light is incident on the circuit board and/or the sidewalls.

10. The lighting device according to claim 9, wherein a first part of yellow light of the yellow light emerge through the phosphor cover, and a second part of yellow light is reflected back to the circuit board and/or the sidewalls.

11. The lighting device according to claim 10, wherein when the optical member is not in the non-reflection state, the second part of yellow light and the third part of blue light are at least partly reflected by the optical member to the phosphor cover.

12. The lighting device according to claim 9, wherein the non-reflection state is full transmission state.

13. The lighting device according to claim 12, wherein the optical member is a liquid crystal screen.

14. The lighting device according to claim 13, wherein when the optical member is in the full transmission state, the second part of yellow light and the third part of blue light pass through the optical member and is incident on the circuit board and/or the sidewalls.

15. The lighting device according to claim 14, wherein the side walls are made of a light absorbing material.

16. The lighting device according to claim 9, wherein the non-reflection state is a full absorption state.

17. The lighting device according to claim 16, wherein the optical member is made of any one of the Mg₂NiHx, Mg₂CoHx and Mg₂FeHx.

18. The lighting device according to claim 17, wherein when the optical member is in the full absorption state, the second part of yellow light and the third part of blue light are absorbed by the optical member.
